(19) United States
(12) Patent Application Publication
(10) Pub. No.: US 2025/0350900 A1
(43) Pub. Date: Nov. 13, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: TORU NAKAGAWA, TOKYO (JP); TETSU MAGARIYACHI, TOKYO (JP)

(21) Appl. No.: 18/862,607

(22) PCT Filed: Apr. 24, 2023
(86) PCT No.: PCT/JP2023/016040

§ 371 Date: Nov. 4, 2024

(30) Foreign Application Priority Data
May 11, 2022 (JP) 2022-077864

(51) Int. Cl. H04S 7/00; H04R 3/04

(52) U.S. Cl. CPC H04S 7/302; H04R 3/04; H04S 7/305

(57) ABSTRACT

The present technology relates to an information processing device, an information processing method, and a program capable of accurately reproducing a reproduced sound in an acoustic space. The information processing device of the present technology includes: a harmonic signal generation unit configured to generate a first signal by convolving, to an input signal, transfer characteristics of harmonic distortion in an acoustic space; and a combining unit configured to combine together the first signal and a second signal, in which sound transmission characteristics excluding the harmonic distortion in the acoustic space is convolved to the input signal. The harmonic signal generation unit convolves, to the input signal respectively processed corresponding to the order the harmonic distortion, the transfer characteristics of the harmonic distortion for each order. The present technology can be applied to, for example, a system that performs audio mixing contents of a movie or the like.

### TECHNICAL FIELD

The present technology relates to an information processing device, an information processing method, and a program, and more particularly, to an information processing device, an information processing method, and a program capable of accurately reproducing a reproduced sound in an acoustic space.

### BACKGROUND ART

Localization of a sound image at a predetermined position and stereoscopic reproduction of a sound heard from headphones can be achieved by convoluting a head related transfer function (HRTF), which indicates sound transfer characteristics in an acoustic space such as a movie theater or a studio, to an audio signal. For example, Patent Document 1 describes that a sound pressure from an audio source at a certain position is actually reproduced by forming and using an HRTF for each individual.

A sound reproducing a sound from an audio source, such as a speaker in a movie theater or a studio, can thus be heard from a headphone.

### CITATION LIST

### Patent Document

Patent Document 1: Japanese Patent Application Laid-Open No. 2015-19360

### SUMMARY OF THE INVENTION

### Problems to be Solved by the Invention

Harmonic distortion occurs in actual movie theaters and studios due to reverberation caused by walls and characteristics of a speaker. Harmonic distortion in movie theaters and studios, however, cannot be reproduced in the reproduced sound using the HRTF.

The present technology has been made in view of such a circumstance, and enables accurate reproduction of a reproduced sound in an acoustic space.

### Solutions to Problems

In one aspect of the present technology, an information processing device includes: a harmonic signal generation unit configured to generate a first signal by convolving, to an input signal, transfer characteristics of harmonic distortion in an acoustic space; and a combining unit configured to combine together the first signal and a second signal, in which sound transmission characteristics excluding the harmonic distortion in the acoustic space is convolved to the input signal.

In one aspect of the present technology, an information processing method includes causing an information processing device to perform processing including: generating a first signal by convolving, to an input signal, transfer characteristics of harmonic distortion in an acoustic space; and combining together the first signal and a second signal, in which sound transmission characteristics excluding the harmonic distortion in the acoustic space is convolved to the input signal.

In one aspect of the present technology, a program causes a computer to execute processing including: generating a first signal by convolving, to an input signal, transfer characteristics of harmonic distortion in an acoustic space; and combining together the first signal and a second signal, in which sound transmission characteristics excluding the harmonic distortion in the acoustic space is convolved to the input signal.

In one aspect of the present technology, a first signal is generated by convolving, to an input signal, transfer characteristics of harmonic distortion in an acoustic space, and the first signal and a second signal, in which sound transmission characteristics excluding the harmonic distortion in the acoustic space is convolved to the input signal, are combined together.

### BRIEF DESCRIPTION OF DRAWINGS

FIG. 1 is a diagram illustrating an example of an HRIR.

FIG. 2 is a diagram illustrating an example of sound transmission characteristics that can be measured in an HRTF measurement environment.

FIG. 3 is a diagram illustrating a configuration example of a sound production system according to an embodiment of the present technology.

FIG. 4 is a diagram explaining a method of measuring the HRTF using a TSP signal.

FIG. 5 is a diagram explaining a method of measuring the HRTF using a Log-TSP signal.

FIG. 6 is a diagram illustrating an example of an impulse response measured by a measuring device.

FIG. 7 is a block diagram illustrating a configuration example of a conventional information processing device.

FIG. 8 is a flowchart explaining reproduction processing performed by the conventional information processing device.

FIG. 9 is a block diagram illustrating a configuration example of an information processing device of the present technology.

FIG. 10 is a flowchart explaining reproduction processing performed by the information processing device of the present technology.

FIG. 11 is a block diagram illustrating another configuration example of the information processing device.

FIG. 12 is a diagram illustrating a display example of a setting screen.

FIG. 13 is a flowchart explaining the reproduction processing performed by the information processing device.

FIG. 14 is a block diagram illustrating a configuration example of hardware of a computer.

### MODE FOR CARRYING OUT THE INVENTION

Hereinafter, modes for carrying out the present technology will be described. The description will be given in the following order.
1. Configuration of sound production system
2. Configuration and operation of information processing device
3. Modification

### <1. Configuration of Sound Production System>

### Overview

Sound images can be stereoscopically reproduced in headphones by using a head related transfer function (HRTF), which indicates sound transfer characteristics from an audio source to both ears in a certain acoustic space.

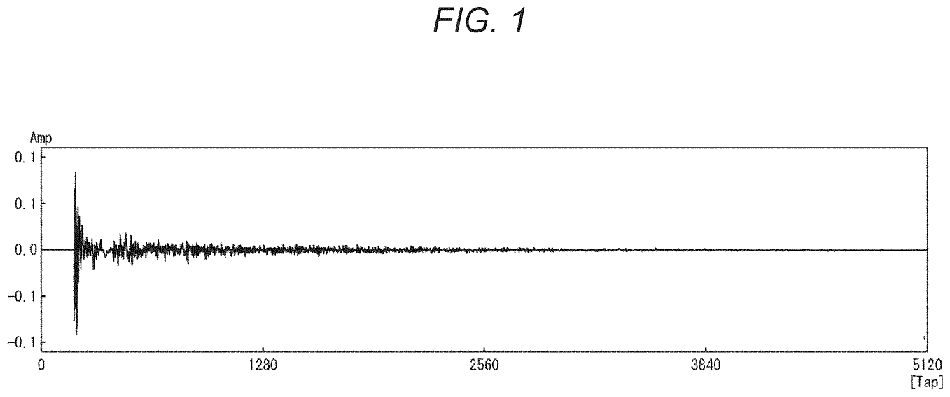

The HRTF which is frequency-domain information is measured, for example, in the form of a head related impulse response (HRIR) which is time-domain information indicating an impulse response from an audio source to both ears of a user in an acoustic space, as illustrated in FIG. 1.

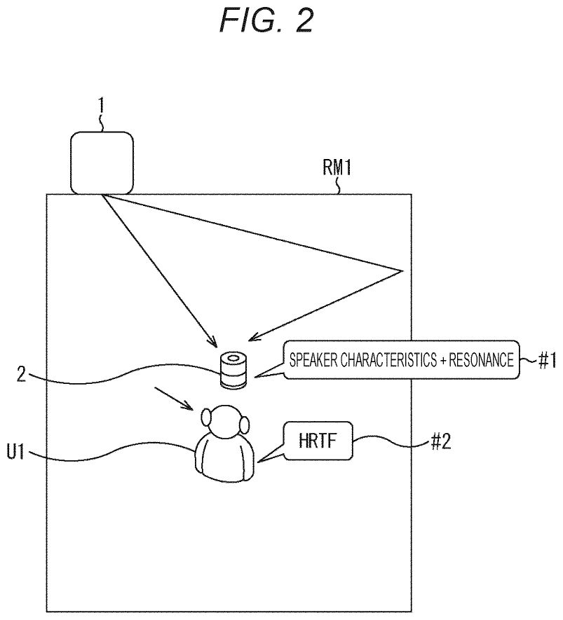

FIG. 2 is a diagram illustrating an example of the sound transmission characteristics that can be measured in an HRTF measurement environment.

A speaker 1 serving as the audio source, is placed in a studio RM1 serving as the HRTF measurement environment. A reproduced sound based on a predetermined measurement signal is output from the speaker 1 and collected by a microphone 2 placed at a predetermined position of the studio RM1, so that characteristics of a sound field of the studio RM1 are measured. The characteristics of the sound field include characteristics of the speaker 1 and a resonance of the studio RM1, as illustrated in balloon #1 of FIG. 2.

The microphone is worn on both ears of a user U1 at an HRTF measuring position. In this state, the reproduced sound based on a predetermined measurement signal is output from the speaker 1 and collected by the microphone worn on both ears of the user U1, so that the HRTF from the speaker 1 to both ears of the user in the studio RM1 is measured, as illustrated in balloon #2.

The measured HRTF is personalized to the user U1 by having the user U1 actually going to the studio RM1 and measuring the HRTF. Note that the method for acquiring the HRTF personalized to the user U1 is not limited to the method in which the user U1 actually goes to the measurement environment and measures the HRTF. The HRTF personalized to the user U1 may be acquired, for example, on the basis of an image capturing the ears of the user U1.

In the studio RM1, the sound output from the speaker 1 is acoustically affected in the order of the characteristics of the speaker 1, the resonance of the studio RM1, a torso, a head, an auricle, and an eardrum of the user U1. The sound output then reaches the eardrum of the user U1. The HRTF from the speaker 1 to both ears thus includes the characteristics of the speaker 1, the resonance of the studio RM1, and the influence on the torso, the head, the auricle, and the eardrum of the user U1.

It is considered that harmonic distortion occurs due to reverberation caused by walls of the studio RM1 or the characteristics of the speaker 1 in a case where, for example, the studio RM1 is wide or the speaker 1 is large.

The conventional sound production system causes a headphone used by the user U1 to output the reproduced sound, which is obtained by convolving to an audio signal the HRTF from the speaker 1 to both ears of the user U1, so that a sound from the speaker 1 in the studio RM1 reproduced. Specifically, a reproduction filter, generated by convolving an inverse function of the HRTF from the headphone to both ears to an HRTF (an SP HRTF) from the speaker 1 to both ears, is convolved to the audio signal. An algorithm for convolving a reproduction filter to an audio signal in the conventional sound production system is a linear system.

On the other hand, the actual system until the reproduced sound reaches both ears of the user U1 in the acoustic space is a non-linear system, so that an algorithm of the conventional sound production system (simple convolution processing) which is a linear system cannot reproduce the harmonic distortion.

An embodiment of the present technology has been conceived focusing on the points described above. The embodiment proposes a technology capable of reproducing a dynamic behavior of a speaker in an acoustic space by acquiring highly accurate sound transfer characteristics including the harmonic distortion in an acoustic space and convolving the transfer characteristics to an audio signal. Hereinafter, the present embodiment will be described in detail.

### Configuration of Sound Production System

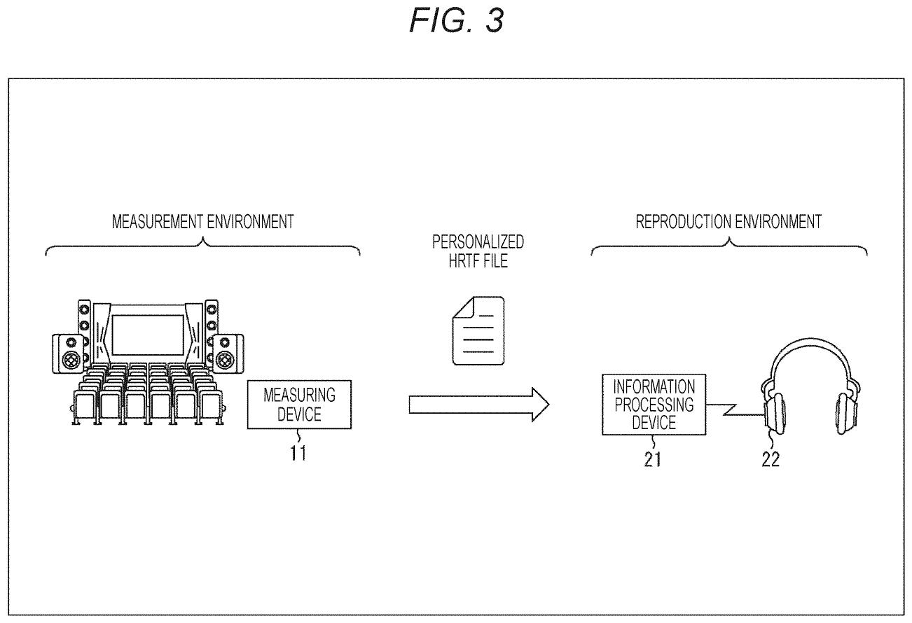

FIG. 3 is a diagram illustrating a configuration example of a sound production system according to the embodiment of the present technology. The sound production system of FIG. 3 is a system that mixes audio of a content, such as a movie. The user uses the sound production system to produce, for example, a sound of a movie.

The sound of the movie includes various sounds such as a sound effect, an environmental sound, and BGM, in addition to voice of a person such as a line or a narration of actors. Hereinafter, in a case where it is not necessary to distinguish the types of sounds, the sounds will be collectively described as a sound. However, the sounds of the movie actually include sounds of types different from a voice.

As illustrated in the left side of FIG. 3, a movie theater referred to as a dubbing stage or the like and used for sound production is a measurement environment. A plurality of speakers is provided in the movie theater, in addition to a screen. The movie theater is also provided with a measuring device 11 that acquires a measurement result of the sound transmission characteristics in the measurement environment and generates an HRTF file. The measuring device 11 is constituted by, for example, a PC.

A personalized HRTF, which is an HRTF personalized to a producer of the sound of the movie, is measured in the measurement environment of the sound production system of FIG. 3. The HRTF of the sound excluding the harmonic distortion in the movie theater and the HRTF of the harmonic distortion for each order in the movie theater are measured as the personalized HRTF.

As indicated by an arrow in FIG. 3, the personalized HRTF file, in which data indicating the measurement result of the personalized HRTF is recorded, is provided to an information processing device 21 provided in a reproduction environment. The personalized HRTF file may be provided to the information processing device 21 via a network such as the Internet or by using a recording medium such as a flash memory.

The reproduction environment is an environment in a place different from the movie theater, such as a studio or home of the producer. The reproduction environment may be prepared at the same place as the measurement environment.

The information processing device 21, which is a device used for editing the sounds of the movie, is provided in the reproduction environment. The information processing device 21 is also constituted by, for example, a PC. The producer uses a headphone 22 in the reproduction environment, such as home, to edit the sound of the movie. The headphone 22 is an output device prepared in the reproduction environment.

The audio signal is reproduced using the personalized HRTF in the information processing device 21. Reproduction using the personalized HRTF reproduces the reproduced sound, which is output from the speaker of the movie theater used for the measurement of the personalized HRTF.

As a result, the producer can perform editing in the same audio environment as that of the movie theater using the headphone 22. That is, the same acoustic environment as that of the movie theater is virtually reproduced in the reproduction environment. Reproduced sounds output from a speaker of a movie theater are typically used, in the environment of producing sounds of a movie, as a reference. The sound production system of the present technology eliminates the need of going to a movie theater, so that the producer can also perform editing at home or the like.

### Method for Measuring HRTF

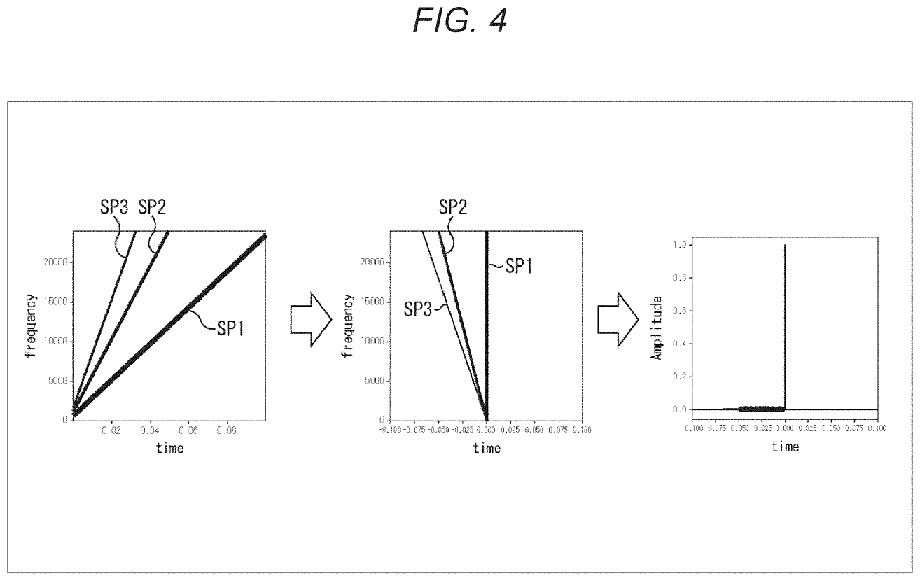

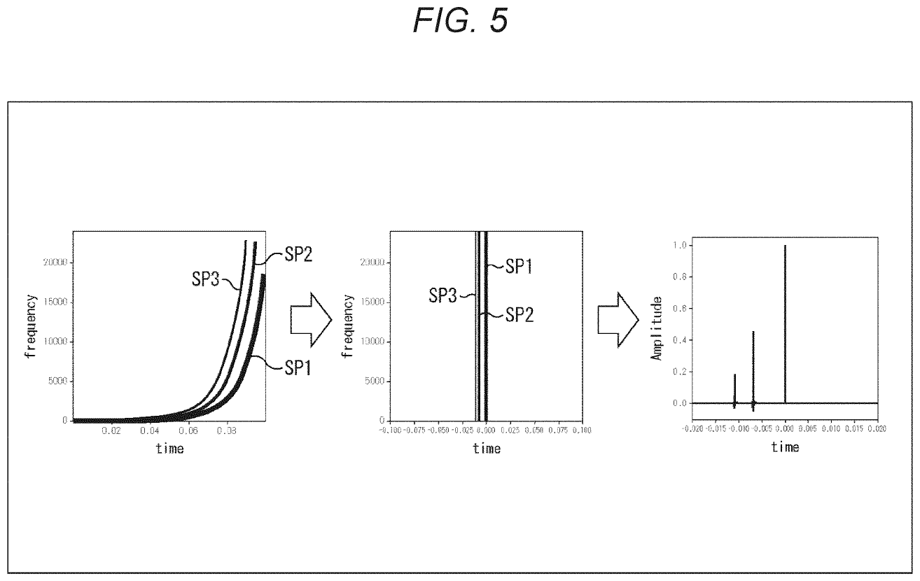

Next, a method for measuring the HRTF by the measuring device 11 will be described with reference to FIGS. 4 and 5. In the conventional impulse response measurement system, one HRTF includes the HRTF of the harmonic distortion and the HRTF of the sound other than the harmonic distortion, so that the HRTF of the harmonic distortion cannot be separated.

In order to separately measure the HRTF of the harmonic distortion, a method is known which uses a swept sine (SS) signal for extracting the harmonic distortion for each order and an impulse response of the sound other than the harmonic distortion. The SS signal is a sinusoidal signal whose frequency rises or falls with time. A time stretched pulse (TSP) signal and a logarithmic time stretched pulse (Log-TSP) signal are known as types of the SS signal.

The TSP signal is a signal whose frequency rises or falls in proportion to time. An example of a time-frequency characteristic of the response in the acoustic space of the TSP signal is illustrated in the left side of FIG. 4. As to the time-frequency characteristic, the horizontal axis represents time and the vertical axis represents frequency. In the example of FIG. 4, SP1 indicates a response of a main signal (a signal other than the harmonic distortion). Furthermore, in the example of FIG. 4, SP2 indicates a response of a second-order harmonic distortion and SP3 indicates a response of a third-order harmonic distortion.

The response of the TSP signal, similar to the TSP signal, increases or decreases in frequency in proportion to time, as illustrated in the left side of FIG. 4.

Transformation of multiplying SP1 to SP3 by inverse characteristics of the main signal aggregates all frequency components of SP1 at the same time, as illustrated in the center of FIG. 4, and an impulse response of the main signal can be obtained. The frequency components of SP2 and SP3, however, are not aggregated at the same time. As a result of measuring an impulse response using TSP signal, therefore, a response of the harmonic distortion, mixed with the second-order harmonic distortion and the third-order harmonic distortion, can be obtained at a time before the main signal response, as illustrated on the right side of FIG. 4.

A Log-TSP signal is, on the other hand, a signal whose frequency increases as an exponential function of time. An example of the time-frequency characteristic of the response of the Log-TSP signal is illustrated in the left side of FIG. 5. SP1 indicates the main signal response also in the example of FIG. 5. Furthermore, in the example of FIG. 5, SP2 indicates the response of the second-order harmonic distortion and SP3 indicates the response of the third-order harmonic distortion.

The frequency of the response of the Log-TSP signal, similar to the Log-TSP signal, increases as an exponential function of time, as illustrated in the left side of FIG. 5. Here, a fundamental wave (the main signal) in the Log-TSP signal is expressed by the following formula (1) and a first-order harmonic is expressed by the following formula (2):

$$[ Math . 1 ]$$

$${f}_{0} ( t ) = {e}^{α t} \qquad ( 1 )$$

$${f}_{1} ( t ) = 2 {e}^{α t} = {e}^{α ( t + {t}_{0} )} = {f}_{0} ( t + {t}_{0} ) \qquad ( 2 )$$

As shown in formula (2), time intervals of the first-order harmonic and the fundamental wave are equal at all frequencies in the Log-TSP signal. Furthermore, in the Log-TSP signal, time intervals of each of harmonics other than the first-order harmonic and the fundamental wave are also equal at all frequencies for each order of the harmonic.

Transformation of multiplying SP1 to SP3 by inverse characteristics of the main signal therefore separately aggregates all frequency components of SP1 to SP3 at one time, as illustrated in the center of FIG. 5. As a result of measuring an impulse response for the Log-TSP signal, therefore, the impulse response of the main signal, an impulse response of the second-order harmonic distortion, and an impulse response of the third-order harmonic distortion are separately obtained, as illustrated in the right side of FIG. 5.

The measuring device 11 measures, using the Log-TSP signal described above, the HRTF of the harmonic distortion for each order and the HRTF of the sound other than the harmonic distortion.

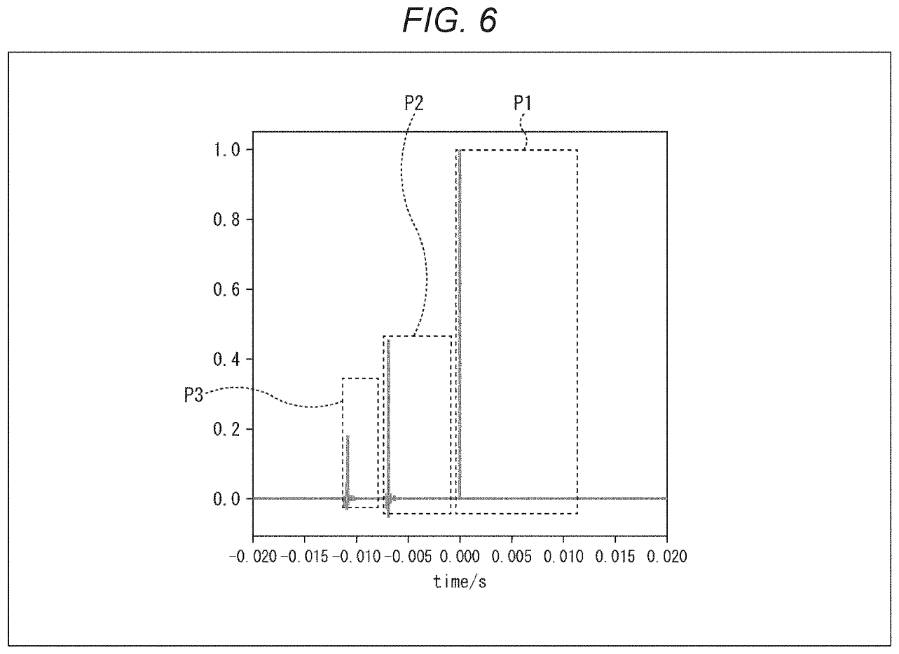

FIG. 6 is a diagram illustrating an example of the impulse response measured by the measuring device 11.

The measuring device 11 measures, for example, the impulse response during a period P1 as the impulse response of the main signal (the HRTF of the sound other than the harmonic distortion). Further, the measuring device 11 measures an impulse response in a period P2 before the period P1 as the impulse response of the first-order harmonic distortion (the HRTF of the first-order harmonic distortion) and measures an impulse response in a period P3 before the period P2 as the impulse response of the second-order harmonic distortion (the HRTF of the second-order harmonic distortion).

The measuring device 11 can thus measure the harmonic distortion for each order using the Log-TSP signal. Note that the order of the harmonic distortion measured by the measuring device 11 in FIG. 6 is an example, and the measuring device 11 is capable of measuring the HRTF of the harmonic distortion up to any order.

### <2. Configuration and Operation of Information Processing Device>

### Configuration and Operation of Conventional Information Processing Device

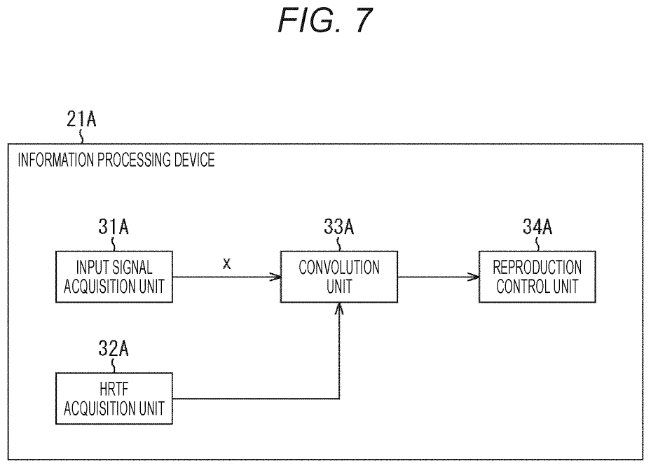

FIG. 7 is a block diagram illustrating a configuration example of a conventional information processing device 21A.

As illustrated in FIG. 7, the conventional information processing device 21A includes an input signal acquisition unit 31A, an HRTF acquisition unit 32A, a convolution unit 33A, and a reproduction control unit 34A.

The input signal acquisition unit 31A acquires, for example, the audio signal of the sound of the movie to be edited as an input signal x and supplies the input signal x to the convolution unit 33A.

The HRTF acquisition unit 32A acquires a personalized HRTF file provided from a device that measures the HRTF, reads the personalized HRTF with reference to the personalized HRTF file, and supplies the personalized HRTF to the convolution unit 33A.

The convolution unit 33A loads the personalized HRTF supplied from the HRTF acquisition unit 32A, as the FIR coefficient of a FIR filter (a finite impulse response), into a memory. The convolution unit 33A generates a reproduction signal, by convolving the FIR filter to the input signal x supplied from the input signal acquisition unit 31A, and supplies the reproduction signal to the reproduction control unit 34A.

The reproduction control unit 34A causes a headphone to output the reproduced sound based on the reproduction signal supplied from the convolution unit 33A.

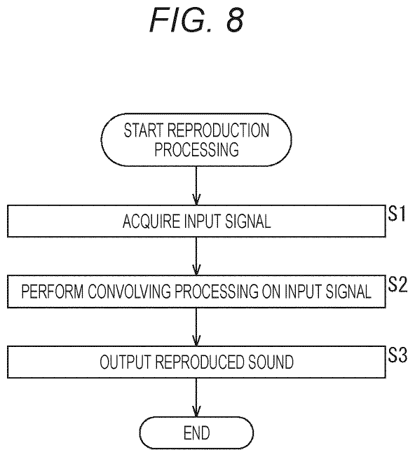

Reproduction processing performed by the conventional information processing device 21A will be described with reference to a flowchart of FIG. 8. For example, the personalized HRTF is loaded into the memory of the convolution unit 33A, as the FIR coefficient, at the start of the reproduction processing of FIG. 8.

In step S1, the input signal acquisition unit 31A acquires an input signal.

In step S2, the convolution unit 33A performs FIR filter convolving processing on the input signal, so that the reproduction signal is generated.

In step S3, the reproduction control unit 34A causes the headphone to output the reproduced sound based on the reproduction signal.

### Configuration and Operation of Information Processing Device of Present Technology

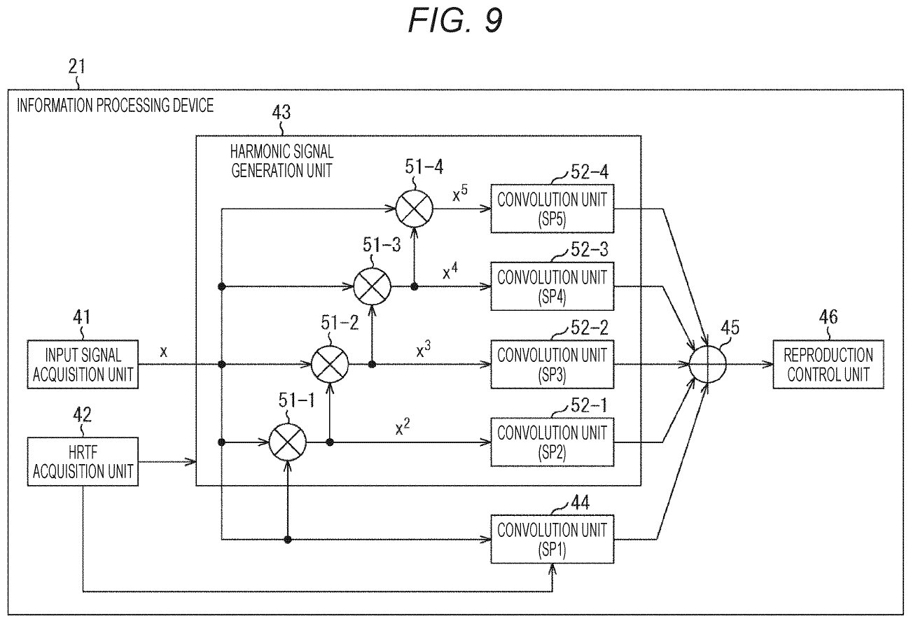

FIG. 9 is a block diagram illustrating a configuration example of the information processing device 21 of the present technology.

In the conventional information processing device 21A illustrated in FIG. 7, one personalized HRTF is convolved to the input signal. In the information processing device 21 of the present technology illustrated in FIG. 9, however, the personalized HRTF of the harmonic distortion is loaded into the memory as the FIR coefficient, for each order of the harmonic distortion, and each personalized HRTF is convolved to the input signal.

The information processing device 21 of the present technology includes, as illustrated in FIG. 9, an input signal acquisition unit 41, an HRTF acquisition unit 42, a harmonic signal generation unit 43, a convolution unit 44, an addition unit 45, and a reproduction control unit 46.

The input signal acquisition unit 41 acquires, for example, the audio signal of a sound of a movie to be edited as an input signal x, and supplies the input signal x to the harmonic signal generation unit 43 and the convolution unit 44.

The HRTF acquisition unit 42 acquires the personalized HRTF file provided from the measuring device 11, reads HRTF_{SP1} which is the personalized HRTF of the sounds other than the harmonic distortion with reference to the personalized HRTF file, and supplies the HRTF_{SP1} to the convolution unit 44. The HRTF acquisition unit 42 also reads the HRTF_{SP2} to HRTF_{SP5} which are the personalized HRTFs of the harmonic distortion for each order with reference to the personalized HRTF file, and supplies the HRTF_{SP2} to HRTF_{SP5} to the harmonic signal generation unit 43.

The harmonic signal generation unit 43 includes multiplication units 51-1 to 51-4 and convolution units 52-1 to 52-4.

The multiplication unit 51-1 multiplies the input signal by the input signal x to generate a harmonic signal x² corresponding to the second-order harmonic distortion, and supplies the harmonic signal x² to the multiplication unit 51-2 and the convolution unit 52-1.

The multiplication unit 51-2 multiplies the input signal x by the harmonic signal x² to generate a harmonic signal x³ corresponding to the third-order harmonic distortion, and supplies the harmonic signal x³ to the multiplication unit 51-3 and the convolution unit 52-2.

The multiplication unit 51-3 multiplies the input signal x by the harmonic signal x³ to generate a harmonic signal x⁴ corresponding to a fourth-order harmonic distortion, and supplies the harmonic signal x⁴ to the multiplication unit 51-4 and the convolution unit 52-3.

The multiplication unit 51-4 multiplies the input signal x by the harmonic signal x⁴ to generate a harmonic signal x⁵ corresponding to a fifth-order harmonic distortion, and supplies the harmonic signal x⁵ to the convolution unit 52-4.

The convolution units 52-1 to 52-4 convolve the HRTF of the harmonic distortion to the harmonic signal, which is generated by multiplying the input signal by the same number as the order of the harmonic distortion.

Specifically, the convolution unit 52-1 loads the HRTF_{SP2} which is the HRTF of the second-order harmonic distortion, as the FIR coefficient, into a memory. The convolution unit 52-1 convolves the FIR filter to the harmonic signal x² to generate a convolution signal and supplies the convolution signal to the addition unit 45.

The convolution unit 52-2 loads the HRTF_{SP3} which is the HRTF of the third-order harmonic distortion, as the FIR coefficient, into a memory. The convolution unit 52-2 convolves the FIR filter to the harmonic signal x³ to generate a convolution signal and supplies the convolution signal to the addition unit 45.

The convolution unit 52-3 loads the HRTF_{SP4} which is the HRTF of the fourth-order harmonic distortion, as the FIR coefficient, into a memory. The convolution unit 52-3 convolves the FIR filter to the harmonic signal x⁴ to generate a convolution signal and supplies the convolution signal to the addition unit 45.

The convolution unit 52-4 loads the HRTF_{SP5} which is the HRTF of the fifth-order harmonic distortion, as a FIR coefficient, into a memory. The convolution unit 52-4 convolves the FIR filter to the harmonic signal x⁵ to generate a convolution signal and supplies the convolution signal to the addition unit 45.

The convolution unit 44 loads the HRTF_{SP1} which is provided from the HRTF acquisition unit 32A, as the FIR coefficient, into a memory. The convolution unit 44 convolves the FIR filter to the convolution signal x, supplied from the input signal acquisition unit 41, to generate the input signal and supplies the convolution signal to the addition unit 45.

Note that, in the convolution unit 44 and the convolution units 52-1 to 52-4, the inverse function of the HRTF from the headphone 22 to both ears of the user, in addition to the personalized HRTF, is also convolved to the input signal and the harmonic signal.

The addition unit 45 functions as a combining unit that adds and combines the convolution signals respectively supplied from the convolution unit 44 and the convolution units 52-1 to 52-4. The addition unit 45 combines the convolution signals to generate the reproduction signal and supplies the reproduction signal to the reproduction control unit 46.

The reproduction control unit 46 causes the headphone 22 to output the reproduced sound based on the reproduction signal supplied from the addition unit 45.

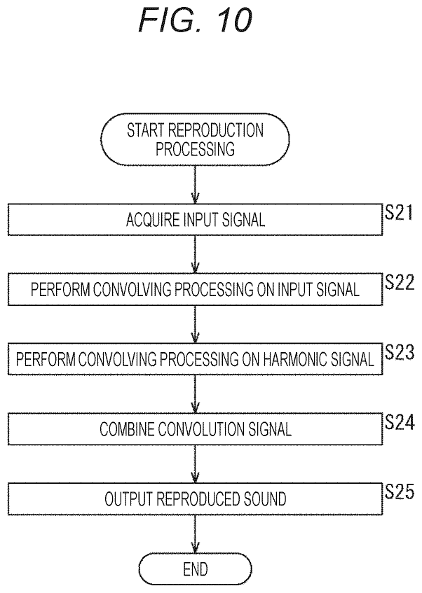

Next, reproduction processing performed by the information processing device 21 of the present technology, having the configuration described above, will be described with reference to a flowchart of FIG. 10. For example, the personalized HRTF is loaded, as the FIR coefficient, into the memory of each of the convolution unit 44 and the convolution units 52-1 to 52-4 at the start of the reproduction processing of FIG. 10.

In step S21, the input signal acquisition unit 41 acquires the input signal. The multiplication units 51-1 to 51-4 generate harmonic signals respectively corresponding to the orders of the harmonic distortions.

In step S22, the convolution unit 44 performs FIR filter convolving processing on the input signal, so that the convolution signal is generated.

In step S23, the convolution units 52-1 to 52-4 perform FIR filter convolving processing on the harmonic signals, respectively corresponding to the orders of the harmonic distortions, so that the convolution signals are generated.

In step S24, the addition unit 45 combines the convolution signals generated in steps S22 and S23, so that the reproduction signal is generated.

In step S25, the reproduction control unit 46 causes the headphone to output the reproduced sound based on the reproduction signal.

As described above, the information processing device 21 combines together the convolution signal in which the HRTF of the harmonic distortion is convolved to the input signal and the convolution signal in which the HRTF other than the harmonic distortion is convolved to the input signal, so that the reproduction signal is generated. The HRTF of the harmonic distortion for each order is convolved to the input signal respectively processed corresponding to the order of the harmonic distortions, such that the HRTF of the second-order harmonic distortion is convolved to the harmonic signal x² and the HRTF of the third-order harmonic distortion is convolved to the harmonic signal x³.

Causing output, from an output device such as the headphone 22, of the reproduced sound based on the reproduction signal generated in this manner enables the sound production system to accurately reproduce the reproduced sound in the acoustic space including the harmonic distortion.

### <3. Modification>

Example of Adjusting FIR Coefficient in Accordance with Sound Pressure

Behavior of the harmonic distortion changes in accordance with a sound pressure of the reproduced sound output from the speaker in the measurement environment. The FIR coefficient may be adjusted in accordance with the sound pressure of the reproduced sound output from the headphone 22 in the reproduction environment.

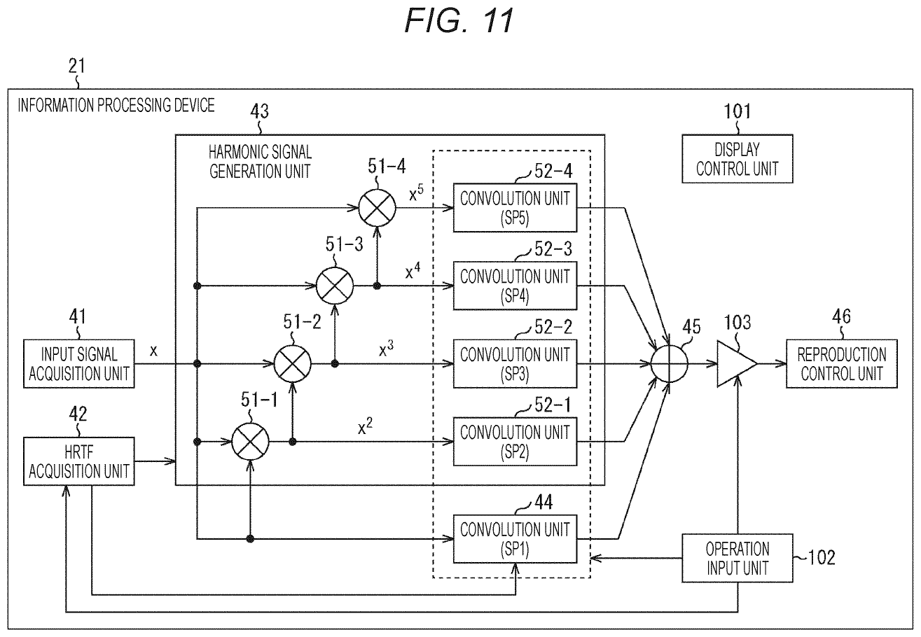

FIG. 11 is a block diagram illustrating another configuration example of the information processing device 21. In FIG. 11, the same components as the components described with reference to FIG. 9 are denoted by the same reference signs. Redundant description will be omitted as appropriate.

The configuration of the information processing device 21 illustrated in FIG. 11 is different from that of the information processing device 21 in FIG. 9 in that a display control unit 101, an operation input unit 102, and an amplifier 103 are provided.

The display control unit 101 causes a display device, such as a display connected to the information processing device 21 in the reproduction environment, to display a setting screen serving as a graphical user interface (GUI) that receives an input of operation to set a target sound pressure, volume, and the like.

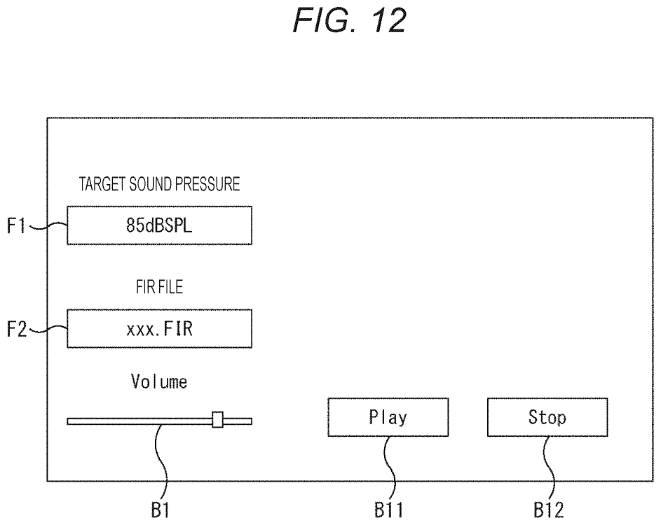

FIG. 12 is a diagram illustrating a display example of the setting screen.

As illustrated in FIG. 12, a form F1 for inputting the target sound pressure is displayed on the upper left side of the setting screen. The user sets the sound pressure (a sound pressure level) of the reproduced sound by, for example, selecting a desired target sound pressure from a plurality of options. In the example of FIG. 12, 85 dBSPL is input as the target sound pressure.

A form F2 for inputting a file name of the personalized HRTF file (an FIR file) used for reproducing the input signal is displayed on the lower side of the form F1. For example, the user selects a desired file from the personalized HRTF files that can be read by the information processing device 21.

A bar B1 for adjusting the volume is displayed on the lower left side of the setting screen. Furthermore, a button B11 for outputting the reproduced sound and a button B12 for stopping the output of the reproduced sound are displayed on the lower right side of the setting screen. The user controls, by operating these displays or the like, reproduction of the input signal by the information processing device 21.

Returning to FIG. 11, the operation input unit 102 receives an input of an user's operation on the setting screen. The operation input unit 102 supplies information indicating content of the operation performed by the user to the HRTF acquisition unit 42, the convolution unit 44, the convolution units 52-1 to 52-4, and the amplifier 103. Note that the target sound pressure and the volume may be set by a method other than the operating on the setting screen.

The HRTF acquisition unit 42 reads the personalized HRTF with reference to the personalized HRTF file set by the user. The personalized HRTF file is recorded with a set of HRTF_{SP1} to HRTF_{SP5} for each sound pressure of the reproduced sound.

The convolution unit 44 and the convolution units 52-1 to 52-4 load the personalized HRTF in accordance with the sound pressure set by the user, as the FIR coefficient, into the memory. Specifically, the convolution unit 44 and the convolution units 52-1 to 52-4 use the personalized HRTF read from the personalized HRTF file as it is or adjust the personalized HRTF read from the personalized HRTF file with a gain or the like, in accordance with the sound pressure set by the user.

Note that the information processing device 21 can also reproduce the reproduced sound in an acoustic space without the harmonic distortion by adjusting the HRTF_{SP2} to the HRTF_{SP5} to 0.

The amplifier 103 adjusts, in accordance with the volume set by the user, the reproduction signal supplied from the addition unit 45 and supplies the adjusted reproduction signal to the reproduction control unit 46.

The reproduction control unit 46 causes the headphone 22 to output the reproduced sound based on the adjusted reproduction signal supplied from the reproduction control unit 46.

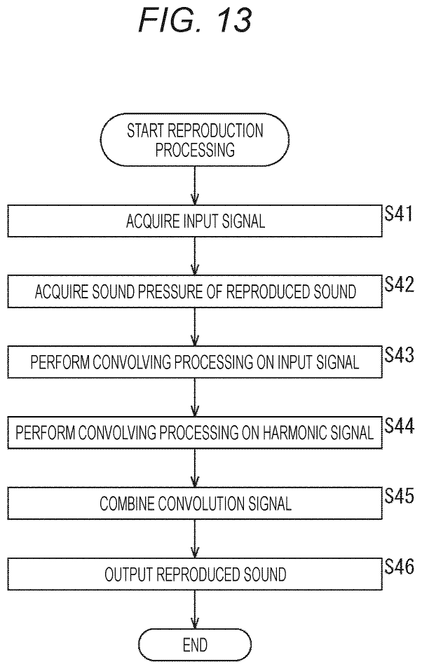

Next, the reproduction processing performed by the information processing device 21 having the forgoing configuration will be described with reference to a flowchart of FIG. 13. For example, at the start of the reproduction processing of FIG. 13, user's input of the file name of the personalized HRTF file is received and the personalized HRTF is loaded into the memory, as the FIR coefficient, from the personalized HRTF file set by the user.

In step S41, the input signal acquisition unit 41 acquires an input signal. The multiplication units 51-1 to 51-4 generate harmonic signals respectively corresponding to the orders of the harmonic distortions.

In step S42, the operation input unit 102 receives an input of an user's operation to set the sound pressure of the reproduced sound and acquires the sound pressure of the reproduced sound. The convolution unit 44 and the convolution units 52-1 to 52-4 load the personalized HRTF in accordance with the sound pressure set by the user, as the FIR coefficient, into the memory.

In step S43, the convolution unit 44 performs FIR filter convolving processing on the input signal, so that the convolution signal is generated.

In step S44, the convolution units 52-1 to 52-4 performs FIR filter convolving processing on the harmonic signals respectively corresponding to the orders of the harmonic distortions, so that the convolution signal is generated.

In step S45, the addition unit 45 combines the convolution signals generated in steps S43 and S44, so that the reproduction signal is generated. The amplifier 103 adjusts, in accordance with the volume set by the user, the reproduction signal.

In step S46, the reproduction control unit 46 causes the headphone to output the reproduced sound based on the reproduction signal.

As described above, the sound production system is capable of reproducing the difference in behavior of the harmonic distortion, in accordance with the sound pressure of the reproduced sound in the measurement environment, and accurately reproducing the reproduced sound in the acoustic space including the harmonic distortion.

### Others

An example has been described above in which the HRTF of the harmonic distortion and the HRTF of the sound other than the harmonic distortion are measured in the acoustic space serving as the measurement environment. However, these HRTFs may be acquired using a method other than measuring, such as acoustic simulation.

### Computer

The series of processing described above can be executed by hardware or by software. In a case where the series of processing is performed by a program constituting, the software is installed on a computer built into dedicated hardware or a general-purpose personal computer from a program recording medium.

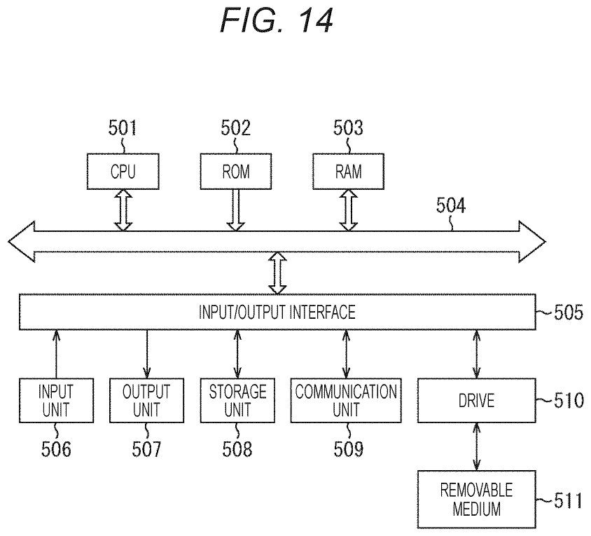

FIG. 14 is a block diagram illustrating a configuration example of hardware of a computer that executes the series of processing described above in accordance with a program. The measuring device 11 and the information processing device 21 is constituted by, for example, a PC having a similar configuration to the configuration illustrated in FIG. 14.

A central processing unit (CPU) 501, a read only memory (ROM) 502, and a random access memory (RAM) 503 are mutually connected via a bus 504.

An input/output interface 505 is also connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processing.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that, in the present specification, a system means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both systems.

Note that the effects described in the present description are merely examples and are not limited, and other effects may be provided.

An embodiment of the present technology is not limited to the embodiment described above, and various modifications can be made without departing from the scope of the present technology. For example, the present technology may be embodied in cloud computing in which a function is shared and executed by a plurality of devices via a network.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### <Combination Examples of Configurations>

The present technology can also be embodied as follows.

(1)

An information processing device including:
a harmonic signal generation unit configured to generate a first signal by convolving, to an input signal, transfer characteristics of harmonic distortion in an acoustic space; and
a combining unit configured to combine together the first signal and a second signal, in which sound transmission characteristics excluding the harmonic distortion in the acoustic space is convolved to the input signal.
   (2)

The information processing device according to (1), in which
the harmonic signal generation unit convolves, to the input signal respectively processed corresponding to the order of the harmonic distortion, the transfer characteristics of the harmonic distortion for each order.
   (3)

The information processing device according to (2), in which
the harmonic signal generation unit convolves, to the input signal multiplied by the same number as the order of the harmonic distortion, the transfer characteristics of the harmonic distortion.
   (4)

The information processing device according to any one of (1) to (3), in which
the harmonic distortion is caused by a speaker characteristic in the acoustic space.
   (5)

The information processing device according to any one of (1) to (4), in which
the harmonic distortion is caused by reverberation in the acoustic space.
   (6)

The information processing device according to any one of (1) to (5), in which
the harmonic signal generation unit convolves, to the input signal, the transfer characteristics of the harmonic distortion measured in the acoustic space.
   (7)

The information processing device according to (6), in which
the transfer characteristics of the harmonic distortion is measured using a Log-TSP signal.
   (8)

The information processing device according to any one of (1) to (7), in which
the harmonic signal generation unit convolves, to the input signal, the transfer characteristics of the harmonic distortion in accordance with a sound pressure of a reproduced sound based on a reproduction signal in which the first signal and the second signal are combined together.
   (9)

The information processing device according to (8), in which
the harmonic signal generation unit acquires, with reference to a file in which the transfer characteristics of the harmonic distortion is recorded for each sound pressure, the transfer characteristics of the harmonic distortion in accordance with the sound pressure.
   (10)

The information processing device according to (8) or (9) further including
a display control unit configured to perform display for receiving an input of user's operation to set the sound pressure.
   (11)

The information processing device according to any one of (1) to (10), in which
the transfer characteristics of a sound, excluding the harmonic distortion personalized to a user, is convolved to the input signal.
   (12)

The information processing device according to any one of (1) to (11), in which
the harmonic signal generation unit convolves, to the input signal, the transfer characteristics of the harmonic distortion personalized to the user.
   (13)

An information processing method including
causing an information processing device to perform processing including:
generating a first signal by convolving, to an input signal, transfer characteristics of harmonic distortion in an acoustic space; and
combining together the first signal and a second signal, in which sound transmission characteristics excluding the harmonic distortion in the acoustic space is convolved to the input signal.
   (14)

A program for causing a computer to execute processing including:
generating a first signal by convolving, to an input signal, transfer characteristics of harmonic distortion in an acoustic space; and
combining together the first signal and a second signal, in which sound transmission characteristics excluding the harmonic distortion in the acoustic space is convolved to the input signal.

### REFERENCE SIGNS LIST

1 Speaker
11 Measuring device
21 Information processing device
22 Headphone
41 Input signal acquisition unit
42 HRTF acquisition unit
43 Harmonic signal generation unit
44 Convolution unit
45 Addition unit
46 Reproduction control unit
51-1 to 51-4 Multiplication unit
52-1 to 52-4 Convolution unit
101 Display control unit
102 Operation input unit
103 Amplifier

1. An information processing device comprising:
a harmonic signal generation unit configured to generate a first signal by convolving, to an input signal, transfer characteristics of harmonic distortion in an acoustic space; and
a combining unit configured to combine together the first signal and a second signal, in which sound transmission characteristics excluding the harmonic distortion in the acoustic space is convolved to the input signal.

2. The information processing device according to claim 1, wherein
the harmonic signal generation unit convolves, to the input signal respectively processed corresponding to the order of the harmonic distortion, the transfer characteristics of the harmonic distortion for each order.

3. The information processing device according to claim 2, wherein
the harmonic signal generation unit convolves, to the input signal multiplied by the same number as the order of the harmonic distortion, the transfer characteristics of the harmonic distortion.

4. The information processing device according to claim 1, wherein
the harmonic distortion is caused by a speaker characteristic in the acoustic space.

5. The information processing device according to claim 1, wherein
the harmonic distortion is caused by reverberation in the acoustic space.

6. The information processing device according to claim 1, wherein
the harmonic signal generation unit convolves, to the input signal, the transfer characteristics of the harmonic distortion measured in the acoustic space.

7. The information processing device according to claim 6, wherein
the transfer characteristics of the harmonic distortion is measured using a Log-TSP signal.

8. The information processing device according to claim 1, wherein
the harmonic signal generation unit convolves, to the input signal, the transfer characteristics of the harmonic distortion in accordance with a sound pressure of a reproduced sound based on a reproduction signal in which the first signal and the second signal are combined together.

9. The information processing device according to claim 8, wherein
the harmonic signal generation unit acquires, with reference to a file in which the transfer characteristics of the harmonic distortion is recorded for each sound pressure, the transfer characteristics of the harmonic distortion in accordance with the sound pressure.

10. The information processing device according to claim 8 further comprising
a display control unit configured to perform display for receiving an input of user's operation to set the sound pressure.

11. The information processing device according to claim 1, wherein
the transfer characteristics of a sound, excluding the harmonic distortion personalized to a user, is convolved to the input signal.

12. The information processing device according to claim 1, wherein
the harmonic signal generation unit convolves, to the input signal, the transfer characteristics of the harmonic distortion personalized to the user.

13. An information processing method comprising
causing an information processing device to perform processing including:
generating a first signal by convolving, to an input signal, transfer characteristics of harmonic distortion in an acoustic space; and
combining together the first signal and a second signal, in which sound transmission characteristics excluding the harmonic distortion in the acoustic space is convolved to the input signal.

14. A program for causing a computer to execute processing comprising:
generating a first signal by convolving, to an input signal, transfer characteristics of harmonic distortion in an acoustic space; and
combining together the first signal and a second signal, in which sound transmission characteristics excluding the harmonic distortion in the acoustic space is convolved to the input signal.
